(19) United States
(12) Patent Application Publication
(10) Pub. No.: US 2026/0264041 A1
(43) Pub. Date: Sep. 10, 2026

(54) MICROREACTOR FOR IMPLEMENTING CONTINUOUS CHEMICAL PROCESSES INVOLVING SOLIDS

(71) Applicant: KHIMOD, PARIS (FR)

(72) Inventors: Eric AUBAY, Paris (FR); Olivier BOUCHARD, Paris (FR)

(21) Appl. No.: 19/167,368

(22) PCT Filed: Mar. 21, 2024
(86) PCT No.: PCT/FR2024/050349

§ 371 Date: Sep. 19, 2025

(30) Foreign Application Priority Data
Mar. 21, 2023 (FR) FR2302628

(51) Int. Cl. B01J 19/00

(52) U.S. Cl. CPC B01J 19/0093; B01J 2219/00033; B01J 2219/0079; B01J 2219/00932; B01J 2219/0099

(57) ABSTRACT

The present invention relates to a continuous chemical reactor comprising a one-piece part (10) provided with a plurality of through-channels (100, 200), each of said channels allowing the flow of a fluid through said one-piece part; and a source for subjecting the part to an ultrasonic wave (ultrasound).

The present invention lies in the field of continuous chemistry in a microreactor. It relates more specifically to the particular field of continuous chemical processes in a microreactor, in which solids are introduced into and/or formed in the microreactor.

The term “continuous chemistry”, which is synonymous with the fuller expression “continuous flow chemistry”, denotes a particular way of implementing a chemical reaction (reaction of one or more reactants resulting in one or more products different than the reactants) and/or a physical reaction (for example crystallization or precipitation) in which the reaction medium is made to flow within a reactor, whereby the reaction is carried out progressively throughout the flow, making it possible, in broad outline, to spatially convert, throughout the flow, the change over time observed in a conventional discontinuous reactor of the round-bottomed flask type.

The present invention relates to continuous chemical reactions of this type which are carried out within reactors of small size, denoted by the generic term “microreactors”. With the meaning as used in the present description, a “microreactor” denotes a device for continuous chemistry, which comprises at least one channel in which the physical and/or chemical reaction takes place and wherein this channel has a cross section with size less than 20 mm, typically less than or equal to 10 mm. The overall dimensions of the region of a continuous chemical microreactor in which the reaction takes place are generally less than 1 m, usually less than or equal to 50 cm, and typically less than or equal to 30 cm.

Continuous chemistry in a microreactor is a burgeoning field, since it makes it possible to carry out chemical reactions in complete safety, including under difficult conditions, while minimizing the reaction volume.

Moreover, continuous chemistry in a microreactor makes it possible to precisely control the temperature of the medium, even in the case of highly exothermic or endothermic reactions, by virtue of the surface to volume ratio, very favorable to heat exchange, allowed by a microreactor.

The use of microreactors also makes it possible to carry out reactions involving high pressure under enhanced safety conditions. The use of a microreactor is, for example, an asset for carrying out hydrogenation reactions, which involve much lower risks with smaller reactors.

Continuous chemistry in a microreactor is also well-suited to the use of toxic or dangerous gases, given that it limits the quantities thereof to which an operator and the environment are potentially exposed. This makes continuous chemistry in a microreactor well-suited to the production of phosgene, for example.

Another advantage of continuous chemistry in a microreactor resides in respect for the environment: it makes it possible, in particular, to minimize the use of solvents and to reduce the formation of coproducts or impurities, which are generally destroyed by incineration.

That being said, a problem encountered by the implementation of continuous chemistry in a microreactor is the presence of solids. The microreactors that are currently known mostly prove to be unsuitable for carrying out chemical reactions that employ solids (reactants or catalysts, for example) or generate solids (solid products or byproducts, precipitates, crystals, etc.), which tend to block all or some of the channels of small cross section that are used in microreactors, impeding the flow and, as a result, disrupting the conditions of the reaction and the possible ways of controlling it, or even completely clogging the microreactor and quickly making it unusable.

This problem is far from negligible given that a very large number of industrially advantageous organic chemistry reactions that can be carried out continuously generate solids (63% of industrially advantageous organic chemistry reactions, according to R. L. Hartman, Organic Process Research & Development, 2012, 16, 870-887). The provision of microreactors that make it possible to manage the presence of solids would therefore make it possible to multiply the use of continuous chemistry on an industrial scale by a factor of 3.

Various solutions have been proposed to attempt to manage the presence of solids in reactions carried out continuously.

In this context, the approach which is currently undergoing the most significant commercial developments consists in developing agitated continuous reactors. Although this provides advantageous results, this approach is not suitable for chemical reactions that require a uniform residence time for the entire flow of reactant, this often being necessary in order to avoid the formation of co-products. Moreover, the temperature and pressure range that is usable in an agitated reactor is limited, thereby restricting the possibilities of intensifying the processes that employ agitated continuous reactors.

Besides this approach, the use of ultrasonic waves (ultrasound) for managing the solids and avoiding clogging in reactors has been described, but the solutions proposed in this context prove to be poorly suited to industrial implementation:
The application WO 2011/023761 describes a method for preventing clogging within a reactor by immersing an ultrasonic source in the liquid duct of the reactor, thereby allowing the propagation of the ultrasound along the channel. A miniature ultrasonic source intended for this type of application is described, for example, in the application CN 210876549.
Another approach, described in the patent application US 2021/197168-A1, consists in immersing a coil, generally a metal coil, in a liquid medium, generally water, into which an ultrasonic source is dipped. In that case, the ultrasound is first of all propagated to the liquid medium, then over the walls of the coil, and finally toward the reaction medium which flows through the coil.
Also described, in particular in CN 208320769 or CN215087044, are plate reactors placed in contact with an ultrasonic source. This type of plate reservoir is made up of a stack of etched plates that are screwed together, these etchings forming channels once the plates are stacked.
According to yet another approach, described, for example, in CN114100530 or CN112403417, an exchanger reactor of the shell type is used, which comprises internal tubes that are set in vibration under the effect of an ultrasonic wave that causes them to oscillate.

Although the employment of ultrasonic waves has been the subject of numerous publications, it has not as yet found specific industrial applications for various reasons, each of which constitutes a brake on the development of this technology.

A first major reason resides in the well-known fact that ultrasound is liable to damage the structure of the reactors within which it is applied.

Furthermore, although the use of ultrasound appears attractive in absolute terms, it has been found in practice that the propagation of the ultrasound is difficult to control in the nonuniform media described in the documents cited above. In particular, the plate reactors and shell reactors in the documents cited above constitute highly nonuniform media, in which the application of ultrasound cannot be carried out uniformly. This difficulty is all the more problematic given that a locally very high and/or poorly controlled power of the ultrasound can lead to the formation of free radicals within the reaction medium, these being liable to entail side reactions, and this can have a negative impact on the purity of production and/or bring about risks that are detrimental to the safety of the process.

An aim of the present invention is to provide a device that makes it possible to implement continuous chemistry in a microreactor in the presence of solids, but avoiding the abovementioned drawbacks.

To this end, the invention proposes a novel type of microreactor implementing a particular application of ultrasonic waves (ultrasound), which makes it possible in particular to avoid the drawbacks of the plate reactors and shell reactors in the documents CN 208320769, CN215087044, CN114100530 or CN112403417, and the inventors of which have shown that it allows effective and uniform, and therefore finely controllable, propagation of the ultrasonic waves through the entire structure of the reactor.

More specifically, according to a first aspect, a subject of the present invention is a continuous chemical reactor comprising:
a one-piece part provided with a plurality of through-channels, each of said channels allowing the flow of a fluid through said one-piece part; and
an ultrasonic source for subjecting the one-piece metal part to an ultrasonic wave.

In the microreactor according to the invention, the through-channels are usually placed in mutual fluidic connection in order to form at least two separate circuits (100; 200), each allowing separate circulation of fluid.

The one-piece part of the microreactor according to the invention is an integral part which has the abovementioned through-channels, which can each contain a fluid and convey a flow of this fluid through the part. Within this one-piece part, the volume occupied by the through-channels typically represents less than 50% and usually less than 40%, or even less than 20% of the total volume of said one-piece part. In other words, the one-piece part used according to the invention is a part in which the internal space is mostly (and preferably substantially) occupied by material rather than by voids.

A one-piece part of thus type has a first advantage, namely significant robustness, which minimizes (or even eliminates) the risks of the part being damaged under the effect of the ultrasonic wave.

Moreover, the use of a one-piece part of the abovementioned type allows optimized propagation of the ultrasonic waves within the part and in the channels, this constituting another advantage of the invention.

In particular, to further enhance this uniformity of the application of the ultrasonic waves, it is preferable for the one-piece part to be a part formed from a single material having a uniform composition throughout the one-piece part, generally a single metal or a single metal alloy. Furthermore, it is preferable for the through-channels to be distributed uniformly in the one-piece part.

The reactor according to the invention proves to be superior to the plate reactors and shell reactors proposed in the prior art not only because of its increased robustness, but also on account of the uniform propagation of the ultrasonic waves that it allows. Such uniformity is not achieved with the plate reactors and shell reactors in particular because they require the use of a plurality of parts (a plurality of plates for the plate reactors; a plurality of internal tubes for the shell reactors) and therefore numerous nonuniform interfaces between these parts to provide the role provided alone by the one-piece part according to the invention, which does not have such interfaces. It should be noted in this regard that the channels present in the one-piece metal parts according to the invention are through-channels, namely open-ended channels which are therefore provided with at least one inlet for introducing fluid into the part and with at least one outlet for discharging a fluid from the part. These channels are therefore located within the one-piece part, thereby distinguishing them in particular from the grooves present on the surface of the plates of the plate reactors. Moreover, the one-piece metal part according to the invention differs from each of the internal tubes of the shell reactors in that there are a plurality of channels.

As indicated, the through-channels present in the one-piece part of a reactor according to the invention are advantageously placed in mutual fluidic connection in order to form at least two separate circuits, each allowing separate circulation of fluid. These separate circuits involve a first part of the channels for the first circuit and another, different part of the channels for the second circuit. These separate circuits formed by the fluidically connected channels may, for example, comprise at least one first circuit allowing circulation of a reaction medium and at least one second circuit allowing circulation of a fluid for thermal regulation. Within a given circuit, the channels can be connected in series, in parallel in a mixed series and parallel manner.

By way of illustration, a circuit of channels that is intended to convey a reaction medium may, for example, have a plurality of inlets corresponding to the inlet of one or more of the channels in the one-piece part, the outlets of which are placed in fluidic connection, thereby allowing the introduction of different fluids into the part and then the mixing thereof; this may, for example, be used to introduce reactants separately, or a flow of reactants and a flow comprising an activator or a catalyst. Alternatively, a circuit of channels that is intended to convey a reaction medium may more simply comprise one inlet and consist, for example, of a plurality of channels of the one-piece part that are connected together in series (for example in the case of a crystallization reaction or any other type of reaction that does not necessarily involve the introduction of separate fluids).

A circuit of channels that is intended to convey a fluid for thermal regulation preferably comprises channels of the one-piece part in parallel, namely channels having fluidically connected inlets (and generally fluidically connected outlets), thereby making it possible to convey in the part a single thermal regulation fluid brought to a single inlet temperature.

The establishment of a fluidic connection between an outlet of one of the channels of the one-piece part and the inlet of another of the channels can be effected by any means known per se. Given the application of the ultrasonic waves, it is preferable, however, to use connection means with integrity that is not affected by these waves. According to one advantageous embodiment, the one-piece part has, for a given fluid circuit, two parallel faces at which all the inlets and all the outlets of the channels involved in said circuit open out; and the reactor has two caps that are held in contact, respectively, with one and the other of these parallel faces, each of the caps having connecting tubes, the openings of which open onto the surface in contact with one of said parallel faces of the one-piece part, next to two openings (one inlet and one outlet) of two channels that open onto said face. The employment of caps of this type makes it possible to easily modify the nature of the circuits produced from the one-piece part, in particular to adapt the desired residence times, this constituting another advantage of the invention. According to another possible embodiment of the invention, all the fluid circuits are produced exclusively within the one-piece part with all of the channels present in the structure of the one-piece part. A one-piece microreactor of this type hollowed out with a more or less complex network of channels is very particularly subject to clogging and would therefore not have been conceivable away from the particular context of the invention.

The ultrasonic source employed according to the invention may be any device that outputs an ultrasonic wave, namely a mechanical wave (also referred to as “ultrasound”) which is capable, in particular, of propagating within the one-piece part and the fluids contained in the channels, and the frequency of which is typically greater than 16 kHz, for example between 16 and 100 kHz, more advantageously between 18 kHz and 50 kHz. The invention involves the application of at least one wave of this type from the source, or a superposition of a plurality of waves of this type, continuously or not continuously. Thus, when the present description refers to the application of an ultrasonic wave, it is intended to cover the application of both a single wave of this type and a plurality thereof, simultaneously or successively. Typically, the ultrasonic source used according to the invention for providing such an ultrasonic wave is a piezoelectric generator (which typically uses a piezoelectric ceramic).

Regardless of its specific nature, the ultrasonic source employed according to the invention is preferably mechanically connected to the abovementioned one-piece metal part, and, even more advantageously, it is preferable for it to be mechanically secured to the one-piece metal part, for example by being screwed onto a threaded rod integral with or welded to the body of said part, or by being screwed onto the metal part by means of a pin screwed on one side to the one-piece metal part and on the other side to the ultrasonic source. This mechanical connection, combined with the one-piece nature of the part comprising the channels that is used according to the invention, allows effective propagation of the ultrasonic waves through the entire structure of the one-piece part, and, from there, through all of the through-channels, with much less attenuation of the wave than in the plate reactors or shell reactors.

These different advantages make it possible to employ the ultrasonic waves for two purposes in a reactor according to the invention when it is used for a physical and/or chemical reaction involving solids.

Within the meaning of the present description, a “physical and/or chemical reaction involving solids” is typically a physical and/or chemical reaction in which:
(i) solids are introduced upstream of the reaction, these being, for example, solid reactants, solid catalysts and/or other solid additives; and/or
(ii) solids are formed by the reaction (precipitates, insoluble reaction products, etc.).

When solids are formed by the reaction, they are dispersed in the reaction medium conveyed through the reactor. Similarly, when solids are introduced upstream of the reaction according to the invention, they are preferably all in dispersion in the reaction medium circulating in the reactor. Preferably, the reaction does not involve reactants, catalysts or additives in the form of solids that are not dispersed. In particular, according to a preferred embodiment, the reaction implemented in a reactor according to the invention does not employ solids voluntarily immobilized on the wall of the reactor, for example catalysts applied as a coating to the walls of the reactor, as described in the application EP 3 241 612.

According to a first possibility, the ultrasonic waves can be employed in a preventative manner in a reactor according to the invention in which a reaction involving solids takes place, namely to avoid the formation of solid deposits within the through-channels, which would otherwise cause a drop in performance of the reactor, or even make it unusable in the case of complete clogging.

More specifically, a particular subject of the present invention is a process for limiting the formation of solid deposits within through-channels in a continuous chemical reactor of the abovementioned type, comprising:
at least one step (e) of physical and/or chemical reaction carried out within at least some of said through-channels, wherein said reaction is effected in the presence of a solid introduced upstream of said through-channels; and/or said reaction results, within the through-channels, in the formation of a solid, and
at least one step (e1) of applying an ultrasonic wave to the one-piece part from the ultrasonic source during said step (e).

The application of ultrasonic waves in the step (e1) can advantageously be effected continuously throughout the step (e). To this end, the application of an ultrasonic wave can be effected in a continuous mode throughout the step (e). According to another possible alternative, the application of the ultrasonic wave can be effected in a pulsed mode, namely by cyclically alternating short periods (typically ranging from 10 ms to 2 seconds) of application of ultrasonic waves, followed by short periods (typically from 200 ms to 5 seconds) without application of ultrasonic waves (referred to as “non-emission periods”).

According to another possibility (compatible, if necessary, with the preceding possibility employing the ultrasonic wave in a preventative manner), the application of the ultrasonic wave can be employed in a “curative” manner in a reactor according to the invention in which a reaction involving solids has previously taken place, namely to eliminate all or part of a solid deposit which has formed within the through-channels during said reaction. In this context, the inventors' work has now revealed that, surprisingly, this elimination proves to be particularly effective when using a microreactor according to the invention, wherein the application of the ultrasonic wave is seen to result in substantial—if not complete—elimination of the solid deposits, as is illustrated by the examples given at the end of the present description.

In other words, another subject of the present invention is a process for eliminating a solid deposit formed within the through-channels of a microreactor of the abovementioned type, comprising:
at least one step (e) of physical and/or chemical reaction carried out within at least some of said through-channels, wherein said reaction is effected in the presence of a solid introduced upstream of said through-channels; and/or said reaction results, within the through-channels, in the formation of a solid, and wherein a solid deposit forms during the step (e); and
at least one step (e2) of applying an ultrasonic wave to the one-piece part from the ultrasonic source after said step (e).

According to one embodiment, the reaction is stopped at the end of the step (e), and then the one-piece part is subjected to the ultrasonic wave during the step (e2).

According to an alternative embodiment, the step (e2) can take place after the formation of a solid deposit has taken place in the step (e), but without otherwise stopping the reaction. In this case, the physicochemical reaction takes place not only in the step (e), in which the solid deposit forms, but also during the step (e2), during which the ultrasonic wave is applied in order to eliminate this deposit while continuing the reaction. In other words, according to this alternative embodiment, the process comprises the following steps:
at least one step (e) of physical and/or chemical reaction carried out within at least some of said through-channels, wherein said reaction is effected in the presence of a solid introduced upstream of said through-channels; and/or said reaction results, within the through-channels, in the formation of a solid, and wherein a solid deposit forms during the step (e); and
at least one step (e2) of applying an ultrasonic wave to the one-piece part from the ultrasonic source after said step (e), with the reaction in the step (e) being continued. When this process is implemented, it is possible, if necessary, during the step (e2), to divert part of the reaction medium, if it is desired to avoid contamination thereof by the solid released during the step (e2). As in the step (e1) described above, the step (e2) can be carried out in a continuous mode or in a pulsed mode, preferably under the conditions described for the step (e1), regardless of the envisioned variant.

Although the conjoint and successive implementation of the steps (e1) and (e2) is not excluded according to the invention, the step (e2) is advantageous especially when the step (e1) is not employed. In this case, the step (e2) is usually implemented only when a solid deposit arises, which results in total or complete clogging, this being detectable in particular by an increase in the pressure loss in the reactor. The step (e2) proves to be particularly effective and allows elimination of the solid deposit and a return to the nominal pressure loss of the reactor after very short application times of the ultrasonic wave, namely, typically, between 1 and 10 minutes and usually less than 3 minutes. This possibility of very rapid and effective post-treatment of the solid deposits, which requires a virtually negligible intervention time in the case of clogging, constitutes another very great advantage of the process according to the invention, which therefore allows, as required, the possibility of dispensing entirely with the preventative embodiment (namely the possibility of not carrying out the step (e1) at all), this having a direct positive impact on the costs of the processes. In particular, the curative treatment according to the invention can be applied while immobilizing the production tool only for very short periods of time (much less than the duration of an intervention involving removal and cleaning out of the ducts in the devices of the prior art, when such an intervention involving removal and cleaning out proves to be possible, this not always being the case with the currently known devices, in which clogging may prove to be irreversible).

Various particular aspects of the invention and possible embodiments are described in more detail in the following text.

### The One-Piece Part and the Channels Passing Through It

The one-piece part of the microreactor according to the invention is preferably made from a single metal or metal alloy, which is preferably chosen from:
steels and in particular stainless steels such as steel 316 L;
nickel-based alloys such as the alloys sold under the trade names Hastelloy, Monel, Inconel, Incoloy, Nimonic, or Nilo;
tantalum;
titanium and its alloys, in particular TA6V;
aluminum and its alloys;
copper and its alloys;
nickel.

Furthermore, the one-piece part of the microreactor according to the invention comprises through-channels which can be formed by any means known per se. These channels may, in absolute terms, be of any shape, for example prismatic or cylindrical (with cross sections that are circular or polyhedral, for example square or rectangular). The one-piece part of a reactor according to the invention may, in particular, be produced by machining a solid block that is not initially provided with channels; by 3D printing; or by assembly and diffusion bonding of a plurality of parts, in order to ultimately form a single part in one piece, the mechanical properties of which are at least as good as those of the constituent parts and the integrity of which is not compromised by the application of an ultrasonic wave.

The one-piece part comprises a plurality of channels of this type, generally at least two and preferably many more than two, typically between 4 and 15 000, typically between 10 and 10 000.

These channels have a straight section having dimensions of preferably less than or equal to 20 mm, and preferably less than or equal to 10 mm, for example less than or equal to 8 mm, and in particular less than or equal to 6 mm.

Thus, for a given channel present within the one-piece part, the cross section of said channel perpendicularly to the longitudinal axis of this channel forms a closed curve (for example a circle or a polyhedron), which preferably has at least one of the following properties:
this curve (the section of the internal wall of the channel) may be entirely included in a circle with a diameter less than 20 mm, preferably less than or equal to 10 mm, for example less than or equal to 8 mm, in particular less than or equal to 6 mm; and/or
the maximum distance between two points of the curve (namely what is conventionally referred to as “the greatest dimension of the section”, for example the diameter for a circle or the diagonal for a square) is less than 20 mm, preferably less than or equal to the abovementioned dimensions, this distance remaining typically greater than or equal to 1 mm, for example between 1 and 20 mm, in particular between 2 mm and 10 mm.

At least some of the through-channels present in the one-piece part are intended to convey the reaction medium in which the reaction for which the reactor is intended takes place, typically the reaction medium in the step (e). The channels conveying the reaction medium (with solids injected or during the reaction) preferably have a cross section forming a curve with no angles (typically a circular section), in order to facilitate the circulation of the solid particles and to avoid the accumulation of solids. These channels are typically cylinders with a circular section having a diameter of between 2 mm and 25 mm, advantageously between 3 and 12 mm, and preferably between 4 and 8 mm.

The length of each of the through-channels present in the one-piece part and intended to convey the reaction medium is generally between 10 and 1000 mm, preferably between 50 and 600 mm, more preferably between 100 and 500 mm.

The one-piece part of the reactor according to the invention is advantageously provided with at least two channels intended to convey the reaction medium, and preferably between 3 and 10 000 channels, for example between 4 and 1000.

In addition to the abovementioned channels intended to convey a reaction medium, it is generally advantageous for some of the through-channels to be intended to convey a fluid for thermal regulation of the reaction that takes place in the reactor. Specifically, the reactor according to the invention proves to be very particularly advantageous for the implementation of exothermic or endothermic reactions in which regulation of this type is necessary. As a result of its design, the reactor according to the present invention allows excellent thermal regulation. In particular in order to optimize the thermal regulation, the channels employed to convey the fluid intended for thermal regulation are preferably channels with a polyhedral, advantageously rectangular, section, this making it possible to maximize heat exchanges. The cross section of these channels is advantageously a rectangle, each of the sides of which has a length ranging from 1 to 10 mm, for example from 1 to 6 mm, in particular from 1 to 4 mm.

The one-piece part of the reactor according to the invention may, for example, comprise both channels for thermal regulation and channels for the passage of the reactants, with a ratio of the number of channels for thermal regulation to the number of channels for the passage of the reactants of between 5:1 and 25:1, preferably between 10:1 and 18:1.

The total volume of the one-piece part of a reactor according to the invention, denoted VT below, may be subdivided into: (1) the cumulative volume of the internal space of the channels intended to convey a reaction medium, referred to as VR; (2) the cumulative volume of the internal space of the channels intended to convey a heat-transfer fluid, referred to as VU; and (3) the volume of the rest of the part (namely of the constituent material of the part, apart from the voids forming the channels), referred to as VR, where VT=VR+VU+VM.

It is generally preferable for the ratio VM/VT to be between 50% and 99.5%, preferably between 60 and 99%, preferably between 80 and 98%, preferably between 90 and 97%.

Furthermore, it is preferred for the part to be provided with two types of channels (intended to convey a reaction medium; and intended to convey a heat-transfer fluid), with a ratio VR/VU of between 4:1 and 1:4, preferably between 2:1 and 1:2.

### The Generation of the Ultrasonic Source Wave

The frequencies of the ultrasonic waves employed in the context of the present invention and generated by the ultrasonic source are preferably between 18 and 50 KHz, preferably between 20 and 35 KHz. These are usually waves belonging to the category referred to as low-frequency power ultrasound.

According to one particular embodiment, the frequency of the ultrasonic wave used according to the invention is a frequency corresponding to a resonant mode of the one-piece part of the reactor. However, this mode is quite optional and it is conceivable, conversely, not to employ an ultrasonic wave of this type in order to avoid resonance of the reactor.

The total power of the ultrasonic wave(s) applied according to the invention, in particular during the abovementioned steps (e1) and/or (e2), is preferably between 10 and 300 W per liter of reactor, preferably between 20 and 100 W per liter of reactor, the reactor volume in liters referred to here being, in this case, the total volume (VT) of the reactor defined above in the present description.

### The Physical Reaction Implemented in the Reactor According to the Invention

The reactor according to the present invention may, in particular, be used for all chemical reactions causing the formation of solids as reaction product and/or as coproduct. It proves to be equally advantageous for the implementation of chemical reactions involving, at the start, an injection of a reactant in solid form or the introduction of solids for some other reason (catalyst or activator, for example, or solids present in the reaction medium treated for other reasons, for example a filler or a support).

The chemical reactions that can be implemented in the reactor according to the invention include organic chemical reactions such as Boc protection, borylation reactions generating lithium borate, carbon-carbon coupling reactions such as Suzuki coupling or Suzuki-Miyaura coupling, carbon-nitrogen coupling reactions such as amination or aldol condensation, reactions involving organometallic compounds such as the Grignard reaction or oxidation reactions using potassium permanganate as oxidizing agent.

They may also be chemical reactions involving heterogeneous catalysts on a moving bed, or the solid catalyst is introduced into the reactor in the form of slurry and is conveyed in the reactant channels with the other reactants. The reactions involving this type of heterogeneous catalyst on a moving bed are, for example, hydrogenation or oxidation reactions.

They may also be inorganic chemical reactions such as the synthesis of precipitated silica, titanium oxide, calcium carbonate, or inorganic phosphates.

The reactor according to the invention may also be used for the syntheses of polymers in emulsion or in dispersion and generally makes it possible to achieve a monodisperse population of polymer particles.

Another very advantageous use of the reactor according to the invention is its use to carry out oxidation reactions in supercritical water, for example for the destruction of organic molecules, in particular very stable toxic organic molecules such as polyfluoro compounds (referred to as “forever chemicals”, which are difficult to destroy otherwise). The reactor according to the invention makes it possible, on account of its specificity, to manage the very particular conditions of this type of reaction. The one-piece structure of the reactor, combined with the possibility of the presence of a temperature regulation circuit makes it possible to employ the high pressures (>221 bar) and high temperatures (>374° C.) required for the supercritical water. More importantly, the reactor according to the invention allows management of the significant precipitation of solids that arise during the reaction (supercritical water acts as an apolar solvent and all of the mineral salts, which are initially dissolved in the water or originate from the oxidation reaction, precipitate). The reactor according to the invention allows proper management of the precipitated solids obtained in this context, avoiding clogging of the reactor.

Other nonlimiting examples of advantageous uses of the reactor according to the present invention include the use thereof to carry out continuous crystallization reactions, forming a suspension of micrometer-scale solid particles of well-controlled size with no risk of clogging of the reactor, the micrometer-scale powder obtained being able to be collected by filtration.

On account of its great modularity and its advantages, the reactor according to the invention can be used in numerous fields including, nonlimitingly, those of health, agronomy, painting, reinforcing fillers, electronics, catalysis or cosmetics.

### BRIEF DESCRIPTION OF THE DRAWINGS

The appended drawings illustrate the invention:

FIG. 1 is a schematic depiction of an illustrative embodiment of a one-piece part as is present in a reactor according to the invention.

FIG. 2 is a partial schematic depiction of the same part, which describes in detail a possible circuit of the reaction medium within twelve channels, this corresponding to the embodiment employed in the illustrative example given below.

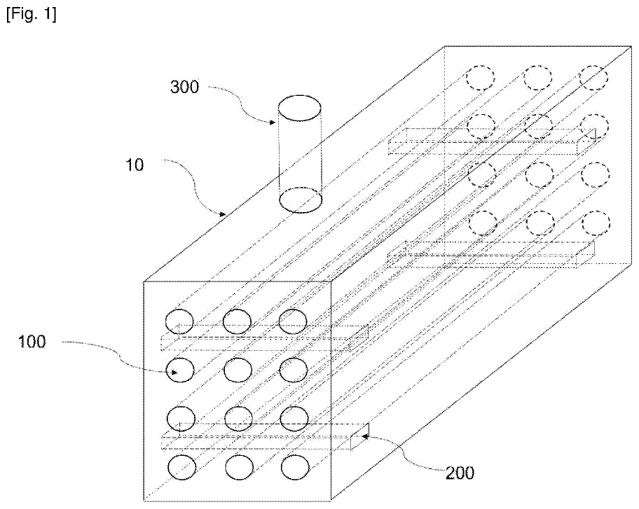

FIG. 1 shows a one-piece part having a body 10, which is generally formed from a single metal or metal alloy and has a first set of channels 100, formed of mutually parallel cylinders with a cylindrical section (twelve in the figure) that are intended to convey a reaction medium, and a second set of channels 200 (of which there are four in the figure in order not to overload the diagram; the part generally comprises more channels, however), which are perpendicular to the channels 100 of the first set, have a parallelepipedal section, and are intended to convey a heat-transfer fluid. The part also has a pin 300, which makes it possible to secure an ultrasonic source to the body 10 by screwing.

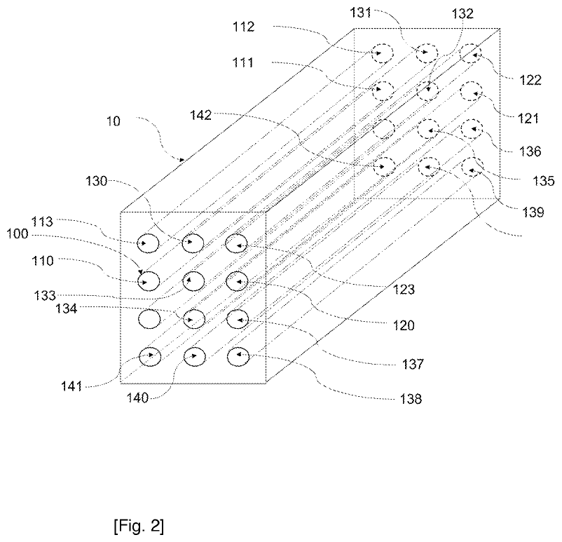

FIG. 2 illustrates a possible example of a circuit produced from the channels in the one-piece part. With reference to this diagram, a possible connection of the inlets and outlets of the channels 100 present in the part 10 will now be described, which can be used to react together two reactants, by bringing a first flow comprising the first reactant (for the example, the circuit will be presented by considering an aqueous solution of barium chloride) into contact with a second flow comprising the second reactant (aqueous solution of sodium sulfate for the example). According to this illustrative embodiment, the solution of barium sulfate is injected through the inlet 110 of a first channel where it is conveyed as far as the outlet 111 of said channel. This outlet 111 is in fluidic contact with the inlet 112 of a second channel (by means of a tube (not shown) which is typically part of a first cap covering the rear part of the body 10 bearing in particular the outlets 111 and 112 and pressed against said part). The solution of barium sulfate is then conveyed as far as the outlet 113 of the channel. In parallel, the solution of sodium sulfate is injected through the inlet 120 of a third channel, from which it exits through the outlet 121, placed in fluidic connection (generally by means of a tube that is typically part of the abovementioned cap) with the inlet 122 of a fourth channel in order to be conveyed as far as the outlet 123. The two outlets 112 and 123 are placed in fluidic connection with the inlet 130 of a fifth tube (generally by means of a tube provided with two inlets and one outlet typically forming part of a second cap placed opposite the abovementioned first cap and pressed against the front face of the body 10, bearing in particular the outlets 110, 113, 120 and 123). A reaction between the barium chloride and the sodium sulfate then occurs, resulting in the formation of a solid precipitate of barium sulfate. The flow of reaction medium now contains a solid and is then conveyed through the rest of the channels as follows:
in a fifth channel, from its inlet 130 to the outlet 131; then
in a sixth channel, from its inlet 132, fluidically connected to the outlet 131 of the fifth channel, to its outlet 133; then
in a seventh channel, from its inlet 134, fluidically connected to the outlet 133 of the sixth channel, to its outlet 135; then
in an eighth channel, from its inlet 136, fluidically connected to the outlet 135 of the seventh, to its outlet 137; then
in a ninth channel, from its inlet 138, fluidically connected to the outlet 137 of the eighth channel, to its outlet 139; then
in a tenth channel, from its inlet 140, fluidically connected to the outlet 139 of the ninth channel, to its outlet 141; then
in an eleventh channel, from its inlet 142, fluidically connected to the outlet 141 of the tenth channel, to its outlet 143. The final reaction medium exits the part 10 through this final outlet 143.

### Example

In this example, use was made of a reactor comprising a parallelepipedal one-piece part measuring 300 mm×70 mm×50 mm corresponding to the embodiment illustrated in the figures and made from a block of metal (stainless steel 316L), passed through by 12 cylindrical channels for the reaction mixture (30 cm long, 6 mm diameter for each of these channels) and by 250 perpendicular channels of rectangular section measuring 2×3 mm for thermal regulation (rather than the four shown in FIG. 1). This reactor also comprises caps providing the fluidic connections of the circuits of reactant reaction medium and thermal regulation, and flanges surrounding the assembly while ensuring the leaktightness of the connections.

A piezoelectric device generating ultrasonic waves with a frequency of 27.6 kHz and a power of 100 W was screwed onto this one-piece part via the pin 300 shown in the figure.

In this example, the system based on sodium sulfate and barium chloride was used, which results in rapid and significant precipitation of the insoluble salt of barium sulfate.

The aqueous solutions of barium chloride and sodium sulfate that are used have a concentration of 0.5 mol/liter and are introduced into the circuit indicated above at a flow rate of 10 ml/minute for each of the two solutions injected. The dispersion of barium sulfate formed is collected at the outlet of the one-piece prat (outlet 143 in FIG. 2). The reactor was temperature-controlled at 18° C. by the circulation of water in the heat-transfer circuit.

A first, control experiment was carried out by continuously injecting the two solutions for a period of 4 hours under the above conditions, without an ultrasonic wave.

The opening of the reactor at the end of the experiment revealed significant clogging of the reactor, at the mixing point of the two reactants (inlet 130). Moreover, the first channel accommodating the mixture (between the inlet 130 and the outlet 131) was 95% blocked by a precipitate of barium sulfate stuck to the walls of the channel of the reactor. Rinsing this device with water did not change the appearance of the precipitate, confirming firm adhesion to the walls of the reactor.

The second experiment carried out consisted in returning the clogged reactor to the state at the start of the control experiment and carrying out the injections, with identical flow rates of the two reactants but this time applying ultrasound with a power of 100 W and a frequency of 27.6 KHz in pulsed mode comprising successive cycles of 1 second of ultrasound followed by 2 seconds without ultrasound, for a total time of 6 minutes.

The opening of the reactor at the end of this experiment revealed a complete absence of precipitate of barium sulfate stuck to the surface of the channels and at the mixing point, this illustrating the embodiment of the invention in which the ultrasonic wave is used for “curative” ends.

A third experiment was carried out on a clean reactor, under conditions identical to the first experiment, but subjecting the reactor to ultrasonic waves with a power of 100 W and a frequency of 27.6 KHz in pulsed mode comprising successive cycles of one second with ultrasound followed by 5 seconds without ultrasound.

After 4 experiment hours, the opening of the reactor revealed the complete absence of precipitate of barium sulfate stuck to the surface of the channels or at the mixing point, this illustrating the embodiment of the invention in which the ultrasonic wave is used for preventative ends.

1. A continuous chemical reactor comprising:
a one-piece part provided with a plurality of through-channels, each of said channels allowing the flow of a fluid through said one-piece part; and
an ultrasonic source for subjecting the one-piece metal part to an ultrasonic wave, wherein the through-channels are preferably placed in mutual fluidic connection in order to form at least two separate circuits, each allowing separate circulation of fluid.

2. The continuous chemical reactor as claimed in claim 1, wherein the one-piece part is a part formed from a single material having a uniform composition throughout the one-piece part.

3. The continuous chemical reactor as claimed in claim 1, wherein the one-piece part comprises between 4 and 15 000 through-channels.

4. The continuous chemical reactor as claimed in claim 1, wherein the channels have a straight section of less than 20 mm, and length of between 10 and 1000 mm.

5. The continuous chemical reactor as claimed in claim 1, wherein the volume taken up by the through-channels within the one-piece part represents less than 50% of the total volume of said one-piece part.

6. The continuous chemical reactor as claimed in claim 1, wherein the through-channels are placed in mutual fluidic connection in order to form at least two separate circuits, each allowing separate circulation of fluid, with at least one first circuit allowing circulation of a reaction medium; and at least one second circuit allowing circulation of a fluid for thermal regulation.

7. The continuous chemical reactor as claimed in claim 1, wherein the ultrasonic source is a device that outputs an ultrasonic wave with a frequency of between 16 and 100 kHz.

8. The continuous chemical reactor as claimed in claim 1, wherein the ultrasonic source employed according to the invention is mechanically connected to the one-piece metal part.

9. A process for limiting the formation of solid deposits within through-channels in a continuous chemical reactor as claimed in claim 1, comprising:
at least one step (e) of physical and/or chemical reaction carried out within at least some of said through-channels, wherein said reaction is effected in the presence of a solid introduced upstream of said through-channels; and/or said reaction results, within the through-channels, in the formation of a solid, and
at least one step (e1) of applying an ultrasonic wave to the one-piece part from the ultrasonic source during said step (e).

10. A process for eliminating a solid deposit formed within the through-channels of a continuous chemical reactor as claimed in claim 1, comprising:
at least one step (e) of physical and/or chemical reaction carried out within at least some of said through-channels, wherein said reaction is effected in the presence of a solid introduced upstream of said through-channels; and/or said reaction results, within the through-channels, in the formation of a solid, and
at least one step of applying an ultrasonic wave to the one-piece part from the ultrasonic source after said step (e), with the physical and/or chemical reaction in the step (e) being continued or not being continued during the step.
